(19) United States
(12) Patent Application Publication
(10) Pub. No.: US 2017/0197604 A1
(43) Pub. Date: Jul. 13, 2017

(54) Pre-Pressurized adaptive Banjo-Bolt Accumulator Valve For Hydraulic Brake Systems and Method

(71) Applicant: Mr. Malik Bachouchi, Toronto (CA)

(72) Inventors: Malik Bachouchi, Toronto (CA); Mark Lipski, Mineola, TX (US)

(21) Appl. No.: 15/408,950

(22) Filed: Jan. 18, 2017

Related U.S. Application Data
(60) Provisional application No. 62/278,111, filed on Jan. 13, 2016.

(51) Int. Cl. B60T 17/04; B60T 17/06

(52) U.S. Cl. CPC B60T 17/043; B60T 17/06

(57) ABSTRACT

The Pre-Pressurized adaptive Banjo-Bolt accumulator valve device is provided, the device being configured to be installed in a Banjo bolt equipped-vehicle's brake system. The Pre-Pressurized adaptive Pre-Pressurized adaptive Banjo-Bolt accumulator valve device is provided includes a housing having an internal bore, outer threads, and a passageway extending from the outer surface of the housing to the internal bore, the internal bore containing brake fluid. The Pre-Pressurized adaptive Banjo-Bolt accumulator valve device is provided also includes a cap, adapted to be fastened to the housing and retain a primary seal. The cap defines the chamber therein, the chamber holding an elastomeric adaptive insert. The Primary seal provides a barrier between brake fluid in the brake system, and the elastomeric insert held within the chamber. A secondary o-ring seal is provided to prevent brake fluid leakage should the primary seal fail and entrapment of compressed elastomeric adaptive insert to initiate pre-pressurization of the membrane when the cap is tightened during assembly.

### TECHNICAL FIELD

The invention relates to vehicle braking systems, more particularly, the present invention relates specifically to Pre-Pressurized adaptive Banjo-Bolt accumulator valve device and method of modulation for Banjo Bolt equipped brake systems

### BACKGROUND OF INVENTION

Conventional hydraulic brake systems used in motor vehicles, such as automobiles, all-terrain vehicles (ATV's), motorcycles, snowmobiles, typically comprise drum brakes or disc brakes. Drum brakes utilize a source of hydraulic pressure to actuate a piston to bias a brake shoe having a friction material surface into contact with a brake drum. Disc brakes utilize a source of hydraulic pressure to actuate a piston to bias a piston to move a brake pad containing friction material into contact with a vertical face of a rotor. Because of the out-of-roundness inherent in brake drums and of the lateral run out inherent in rotors, the friction element alternately engages low and high spots on the brake drum or rotor. Because of the relative incompressibility of the brake fluid the pressure in the brake system experiences a sharp increase when the friction element engages a high spot on the drum or rotor and experiences a relative pressure decrease when the friction element rubs a low spot on a drum or rotor. These pressure fluctuations which occur in the brake fluid cause pressure waves, surges, spikes and harmonics to propagate through the hydraulic system, thereby decreasing performance of the system.

Typically, a pressure wave would move from a wheel cylinder or disk brake piston to the brake master cylinder and thereafter be reflected back from the master cylinder to the wheel cylinder or brake caliper piston. Very high momentary braking pressures occur within the hydraulic system when the reflected pressure waves, surges, spikes and harmonics moving toward the brake cylinder or piston add to clamping force already exerted thereon.

In common vehicle hydraulic brake systems one or more wheels of the vehicle may lock or skid during severe braking applications while the other wheels are rotating which may cause the vehicle operator to experience a loss of control. It may be demonstrated that wheel lockup occurs because a friction element becomes “stuck” on a so-called high spot on a disk brake drum or rotor. This wheel lockup occurs because the high spot initiates a high pressure wave into the hydraulic system which moves from a wheel cylinder or brake piston towards the master cylinder and reflects back through the brake line and adds to the clamping force already exerted on the shoe or caliper. In addition, wheel lockup may occur because of a traction differential at two or more of the tires, due to adverse road conditions such as snow, ice, sand, gravel, etc.

Consequently, it has been found that the addition of a small accumulator to the hydraulic system will absorb pressure surges to maintain a constant fluid pressure at each actuator piston and thereby reduce the tendency of a friction element to prematurely become “stuck” on a brake drum or rotor high spot.

Previous solutions to the problem of reducing wheel lock-up typically rely on the use of accumulators. Such accumulators typically function to reduce pressure surges within a vehicle brake system, and they suffer a number of disadvantages. To begin with, the devices are not universally applicable to all vehicle hydraulic systems. As an example, the hydraulic brake system for a motorcycle contains a small volume of fluid compared to the volume of brake fluid in an automobile or truck or bus hydraulic system. Thus, a different accumulator must be manufactured for each of these systems. Additionally, the accumulators do not discriminate between vehicles, which are heavy or light in weight, vehicles that carry a large percentage of their weight on the front of the vehicle as opposed to the rear of the vehicle and high performance vehicles such as racing cars, which have different braking requirements than conventional passenger cars. Accumulators must be custom made for each application. Also, in the past it has been difficult to obtain an accumulator that will provide the optimum amount of brake pedal pressure or the optimum amount of brake travel required during the braking process. Additionally, prior accumulators have been unable to provide a desired feel of the brake pedal or feedback from the brake pedal to the operator during the brake process in vehicle brake system with accumulator. In some vehicle applications the brake pedal may feel spongy whereas in other vehicle applications the brake pedal may feel very stiff to an operator after an accumulator has been installed. Also, in some vehicle applications a relatively large amount of brake pedal travel occurs whereas in other applications very little brake travel occurs as a result of the addition of an accumulator within the vehicle hydraulic system. Furthermore, neither of the aforementioned previous accumulator devices provides a simple means of adjusting the device to obtain a desired or proper brake pedal feel or amount of travel.

In certain accumulator-type devices, their addition to a vehicle hydraulic brake system requires that the accumulator device must be initialized prior to obtaining proper operation thereof. Such an initialization requires that a vehicle operator make several severe braking applications or panic stops subsequent to installation of the device. This initialization must occur each time the integrity of the hydraulic system is disturbed.

From the above, it may be seen to be desirable to provide a simple pressure control device for a vehicle hydraulic brake system which may be adjusted readily to provide an optimum brake pedal feel and travel amount for any desired vehicle, which does not require an initialization process subsequent to installation which may be utilized in vehicles having large or small volume hydraulic systems, which will accommodate light or heavy vehicles or vehicles which have a greater percentage of vehicle weight on one end of the vehicle or the other, which will work satisfactorily on high performance vehicles and which maintains a more constant brake pedal feel and amount of travel without regard to temperature influence.

### SUMMARY OF INVENTION

In one embodiment, the present invention comprises a Pre-Pressurized adaptive Banjo-Bolt accumulator valve device configured to be installed in a vehicle's brake system replacing the banjo bolt. The Pre-Pressurized adaptive Banjo-Bolt accumulator valve device includes a housing having an internal bore, outer threads, and a passageway extending from the outer surface of the housing to the internal bore, the internal bore containing brake fluid. The Pre-Pressurized adaptive Banjo-Bolt accumulator valve device also includes a cap, adapted to be fastened to the housing and retain a primary seal. Cap defines a chamber therein, the chamber holding an elastomeric adaptive insert compressed at assembly time. The primary seal provides a barrier between brake fluid in the brake system and the elastomeric adaptive insert compressed held within the chamber.

The Pre-Pressurized adaptive Banjo-Bolt accumulator valve device may be installed in a number of applications. The device is installed at the caliper or the master cylinder at either end of the brake line; the device replaces the existing banjo bolt.

In a further embodiment, the present invention is used with hydraulic systems other than vehicle braking systems. For example, the present invention may be used with hydraulic operating systems on stationary or mobile machinery. Such a hydraulic fluid modulation device is integrated with the hydraulic operating system that initiates electric modified pulses found in electronic ABS; anti-lock brake systems in a similar way as when integrated with vehicle braking systems.

### BRIEF DESCRIPTION OF THE DRAWINGS

The present invention can be more completely understood and appreciated by referring to the following more detailed description of the presently preferred exemplary embodiments of the invention in conjunction with the accompanying drawings, of which:

FIG. 1 is a cross-sectional view of an embodiment of a Pre-Pressurized adaptive Banjo-Bolt accumulator valve device according to the present invention.

FIG. 2 is a perspective view of a Pre-Pressurized adaptive Banjo-Bolt accumulator valve device according to the present invention.

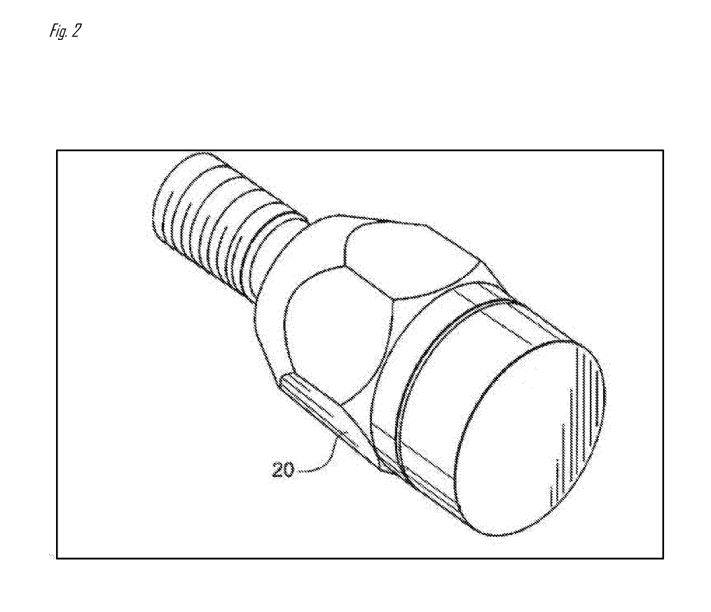

### DETAIL DESCRIPTION OF THE DRAWINGS

In the following detailed description of the present invention, numerous specific details are set forth in order to provide a thorough understanding of the present invention.

However, it will be apparent to one skilled in the art that the present invention may be practiced without these specific details. In other instances, well-known methods, procedures, and components have not been described in detail so as to not unnecessarily obscure aspects of the present invention.

In one embodiment, the present invention is intended for use with any vehicle utilizing a hydraulic braking system and a Banjo Bolt, such as but not limited to motorcycles, all-terrain vehicles, and the like.

Referring now generally to the Figures, a Pre-Pressurized adaptive Banjo-Bolt accumulator valve device 20 is depicted. The device 20 generally comprises a housing 22, a cap 24, and a seal or diaphragm 26. Housing 22 includes an engagement portion 32, an internal bore 34, and an expanding shape fluid reservoir 36. Engagement portion 32 is threaded so as to be compatible with standard banjo bolts on braking systems. Internal bore 34 begins at the proximate end 38 of the device, and extends up to fluid reservoir 36. Bore 34 provides fluid communication from reservoir 36 to the braking fluid line in which device 20 is installed. At distal end 40 is the top of device 20, which is configured to receive cap 24. Housing 22 of device 20 may also include a hexagonal profile to facilitate installation with a wrench.

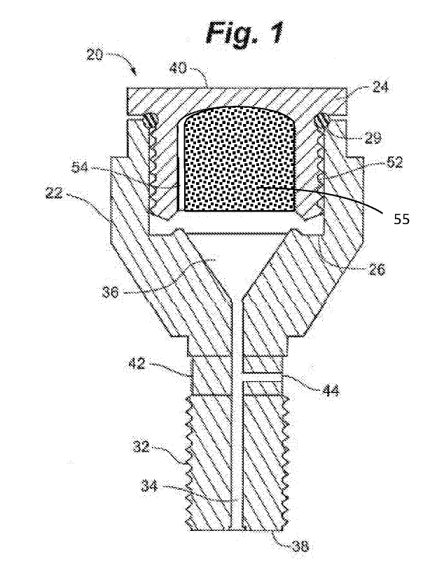

Device 20 which replaces a pre-existing banjo bolt on the brake system of a vehicle, housing 22 also includes a recessed area 42 to accept a banjo fitting, and a passageway 44 from recess 42 to internal bore 34, such as depicted in FIGS. 1.

Cap 24 is configured to be coupled to housing 22. Cap 24 includes a threaded portion 52 for coupling cap 24 to housing 22. A chamber 54 is defined within cap 24, wherein chamber 54 is configured to store a compressible elastomeric adaptive insert 55 of lower durometer hardness than the diaphragm 26 at assembly time. The adaptive insert 55 in chamber 54 could be function of different parameters such as the membrane 26, the type of vehicle, the weight of the vehicle, usage on front or back break apparatus, the expected riding comfort and other riding parameters. The adaptive insert 55 will, with time adapt to the user driving style by deforming permanently and giving the optimal pre-presurization of the membrane 26.

Cap seal 29 also act to seal chamber 54.

Diaphragm or primary seal 26 is located between compressed adaptive insert 55 in chamber 54 in cap 24 and fluid reservoir 36 in housing 22. Diaphragm 26 is made from an elastomer, or other suitable material having a known deformation characteristic. Diaphragm 26 is secured within housing 22 by cap 24 being threaded down on to diaphragm 26, such as depicted in FIG. 1. During operation, diaphragm 26 deforms or deflects to modulate the braking system of a vehicle in which device 20 is installed.

The installation method is to remove a pre-existing banjo bolt in a vehicle caliper, and replace it with device 20. The banjo fitting on the brake line of the vehicle is installed on housing 22 of device 20, around recess 42, and device 20 is tightened into the caliper or master cylinder.

Referring now to operation of Pre-Pressurized adaptive Banjo-Bolt accumulator valve device 20, a vehicle brake system typically includes at least the following components: a master cylinder, one or more calipers/drums, brake lines, and fittings. When device 20 is installed by replacing the banjo bolt and thereby fluidly integrated with the brake system of a vehicle, brake fluid is present in internal bore 34 and therefore fluid reservoir 36 of housing 22. As a user applies the brakes of a vehicle by stepping on a brake pedal or pulling a brake lever, brake fluid is moved from the master cylinder to the piston within the caliper/drum. Additionally, as a user applies the vehicle's brakes, brake fluid expands within the fluid reservoir may deform or deflect diaphragm 26, depending on the pressure applied by the user, the shape of the reservoir and the stiffness of diaphragm 26. Deflection of diaphragm 26 changes the adaptive insert 55 pressure within the chamber 54. The expanding shape of the reservoir 36 will dampen the shock wave prior to deforming the deforming the membrane, allowing for a smoother breaking operation.

While the user is applying the brakes, Pre-Pressurized adaptive Banjo-Bolt accumulator valve device 20 provides a modulation feature to lessen the affect of various imperfections in the brake system of the vehicle. Such imperfections may be out of true rotors or drums, stuck caliper pistons or a stuck floating caliper or rotor. Ordinarily, such imperfections in the brake system could lead to wheel lock-up, however, the present invention provides for continued braking performance and resists lock-up due to such imperfections. Additionally, adverse road conditions may contribute to wheel lock-up, such as sand, gravel, mud, or slick or icy roads. The adverse road condition may be uniform across the road surface such that all wheels of the vehicle are subject to the road condition, or may be on only part of the road surface, such that there may be a friction differential between one or more wheels of the vehicle.

If a pressure fluctuation or Shockwave is introduced into the fluid of the brake system, such as by an out-of-true brake rotor, diaphragm 26 and adaptive insert 55 in chamber 54 are able to absorb some or all of the shock wave. Absorption of the pressure shockwave is handled by first the expanding shape reservoir then the deflection of diaphragm 26 and finally by adaptive insert 55 pressure change within chamber 54 , and an incidence of wheel lock-up is thereby reduced. Pre-Pressurized adaptive Banjo-Bolt accumulator valve device 20 may perform as a spring, damper, dashpot, shock absorber, or damped spring, depending on the desired and selected characteristics of the diaphragm 26 and the adaptive insert 55 type and at-rest pressure within chamber 54.

The amount of modulation provided by device 20 may be adjusted by modifying one or more characteristics of diaphragm 26, such as the thickness of diaphragm 26, the durometer reading of the material, or the material used or the shape of the reservoir 36. The amount of modulation may also be adjusted by modifying the at-rest pressure of the adaptive insert 55 within chamber 54, as well as the size of chamber 54.

The Pre-Pressurized adaptive Banjo-Bolt accumulator valve device may have different characteristics for different vehicles. For example, vehicles of heavy weight will likely use a stiffer diaphragm than will be used on a vehicle of light weight. Additionally, it may be desirable on the front of a vehicle to use a stiffer diaphragm than on the rear of the vehicle, as the majority of a vehicle's stopping power is provided by the brakes on the front of the vehicle.

Although the present invention is described in one embodiment as a Pre-Pressurized adaptive Banjo-Bolt accumulator valve device , it will be appreciated by one skilled in the art that other embodiments and applications exist for the device. For example, the present invention is readily adaptable for use with hydraulic machinery or hydrostatic drive systems, such as may be found on forklifts, heavy equipment, construction equipment, tractors, turf care equipment, and so forth. The present invention is also suitable for use with non-vehicular hydraulic systems, such as stationary machinery, manufacturing equipment, robotics, and so forth. Hydraulic systems as discussed in this paragraph may experience pressure fluctuations, spikes, surges, or waves, similar to the pressure fluctuations previously discussed herein in relation to vehicle brake systems. As such, the addition of the present invention to any hydraulic operating system results in smoother operation of the hydraulic system by eliminating or reducing the magnitude of pressure fluctuations occurring within the system.

The above disclosure is not intended as limiting. Those skilled in the art will readily observe that numerous modifications and alterations of the device may be made while retaining the teachings of the invention. Accordingly, the above disclosure should be construed as limited only by the restrictions of the appended claims.

What is claimed is:

1. A Pre-Pressurized adaptive Banjo-Bolt accumulator valve device, comprising:
A fluid expanding shape reservoir adapted to be in communication with fluid in a brake system of a vehicle;
A sealed chamber; and
A diaphragm separating the fluid reservoir and the chamber, the diaphragm adapted to deform under pressure from hydraulic fluid in the fluid reservoir

2. The device of claim 1, wherein the sealed chamber comprises a compressed adaptive insert pressurized at assembly time.

3. The device of claim 1, wherein the reservoir has expanding shape geometry.

4. The device of claim 1, is a contained apparatus replacing the Banjo Bolt in a straight and seamless one-device-for-one-device replacement.

5. A method of modulating a vehicle hydraulic brake system, comprising:
I. Providing a modulation device, including:
An expanding shape fluid reservoir adapted to be in communication with hydraulic fluid in the system;
A sealed chamber; and
A diaphragm separating the fluid reservoir and the chamber;
II. Installing the device such that the fluid reservoir is in communication with fluid in the vehicle hydraulic brake system; and applying a brake pedal to create pressure in the vehicle hydraulic brake system, wherein the diaphragm is deformed under the pressure.

6. The method of claim 5, wherein the sealed chamber includes a elastomeric compressed adaptive insert is at least partially compressed from the diaphragm being deformed, using the adjustment mechanism to modify one or more modulating characteristics of the brake device.

7. A hydraulic fluid modulation device for use in a hydraulic operating system, comprising:
An expanding shape fluid reservoir adapted to be in communication with hydraulic fluid in the system;
A sealed chamber; and
A diaphragm separating the fluid reservoir and the chamber, the diaphragm adapted to deform under pressure from hydraulic fluid in the fluid reservoir.

8. The device of claim 7, wherein the sealed chamber comprises a compressed elastomeric adaptive insert pressurized at assembly time.

9. The device of claim 7, wherein the reservoir has expanding shape geometry. ID. A brake system for a vehicle, comprising:
A master cylinder;
A brake caliper;
A brake line coupling the caliper to the master cylinder; and
A Pre-Pressurized adaptive Banjo-Bolt accumulator valve device fluidly integrated with the vehicle brake system, including:
An expanding shape fluid reservoir adapted to be in communication with hydraulic fluid in the system;
A sealed chamber; and
A diaphragm separating the fluid reservoir and the chamber, wherein the fluid reservoir is in fluid communication with a brake system of a vehicle.

11. The system of claim ID, wherein the sealed chamber comprises an adaptive insert pressurized at assembly time.

12. The device of claim ID, wherein the reservoir has expanding shape geometry.
